(19) United States
(12) Patent Application Publication
(10) Pub. No.: US 2022/0066007 A1
(43) Pub. Date: Mar. 3, 2022

(54) LIGHT DETECTION AND RANGING SYSTEM

(71) Applicant: DELTA ELECTRONICS, INC., Taoyuan City (TW)

(72) Inventors: Gow-Zin YIU, Taoyuan City (TW); Ching-Nien CHEN, Taoyuan City (TW)

(21) Appl. No.: 17/385,882

(22) Filed: Jul. 26, 2021

(30) Foreign Application Priority Data
Aug. 31, 2020 (CN) 202010895030.9

(51) Int. Cl. G01S 7/497; G01S 7/481

(52) U.S. Cl. CPC G01S 7/4972; G01S 7/4812

(57) ABSTRACT

A light detection and ranging (LiDAR) system is provided. The light detection and ranging system includes a first driver, a first light emitting element, and a first detector. The first driver is configured to drive the first light emitting element to emit light. The first detector is configured to detect power of the light.

### RELATED APPLICATIONS

This application claims priority to Chinese Application Serial Number 202010895030.9, filed Aug. 31, 2020, which is herein incorporated by reference.

### BACKGROUND

### Technical Field

The present disclosure relates to a light detection and ranging (LiDAR) system. More particularly, the present disclosure relates to a LiDAR system which can detect power in real time.

### Description of Related Art

With developments of technology, light detection and ranging (LiDAR) systems have been used in many fields. In some related approaches, power of a light emitting element in a LiDAR system is measured at test phase or before leaving the factory. However, it cannot ensure that the light emitting element will work normally in subsequent operations.

### SUMMARY

Some aspects of the present disclosure are to provide a light detection and ranging (LiDAR) system. The LiDAR system includes a first driver, a first light emitting element, and a first detector. The first driver is configured to drive the first light emitting element to emit light. The first detector is configured to detect power of the light.

As described above, the Lidar system of the present disclosure can measure the power of the light emitting element in real time, to increase the reliability of the Lidar system. In addition, in some embodiments, the detector is disposed between the driver and the light emitting element to reduce space, so as to avoid increasing the volume of the LiDAR system and complex light path. Furthermore, the Lidar system of the present disclosure has advantages of ease to arrangement and low cost.

### BRIEF DESCRIPTION OF THE DRAWINGS

The disclosure can be more fully understood by reading the following detailed description of the embodiment, with reference made to the accompanying drawings as follows:

FIG. 1A is a schematic diagram of a light detection and ranging (LiDAR) system according to some embodiments of the present disclosure.

FIG. 1B is a top view diagram of a driver, a detector, and a light emitting element in FIG. 1A according to some embodiments of the present disclosure.

FIG. 1C is a side view diagram of a light emitting element according to some embodiments of the present disclosure.

FIG. 1D is a top view diagram of the light emitting element in FIG. 1C according to some embodiments of the present disclosure.

FIG. 2A is a top view diagram of a driver, a detector, and a light emitting element according to some other embodiments of the present disclosure.

FIG. 2B is a top view diagram of a driver, a detector, and a light emitting element according to some other embodiments of the present disclosure.

FIG. 3A is a schematic diagram of a LiDAR system according to some embodiments of the present disclosure.

FIG. 3B is a top view diagram of a driver, a detector, and a light emitting element in FIG. 3A according to some embodiments of the present disclosure.

FIG. 4 is a schematic diagram of a LiDAR system according to some embodiments of the present disclosure.

### DETAILED DESCRIPTION

The embodiments in the following descriptions are described in detail with the accompanying drawings, but the examples provided are not intended to limit the scope of the disclosure covered by the present disclosure. The structure and operation are not intended to limit the execution order. Any structure regrouped by elements, which has an equal effect, is covered by the scope of the present disclosure. In addition, the drawings are merely for illustration and are not illustrated according to their original sizes. For ease of understanding, the same or similar components in the following descriptions will be described with the same symbols.

In the present disclosure, “connected” or “coupled” may refer to “electrically connected” or “electrically coupled.” “Connected” or “coupled” may also refer to operations or actions between two or more elements.

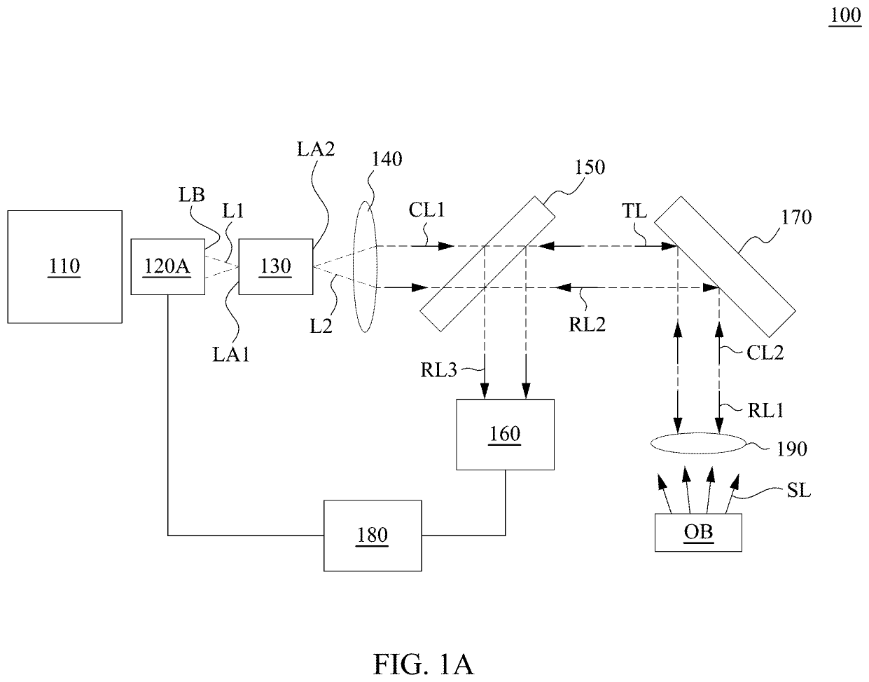

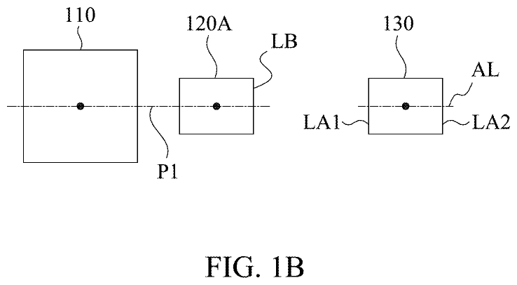

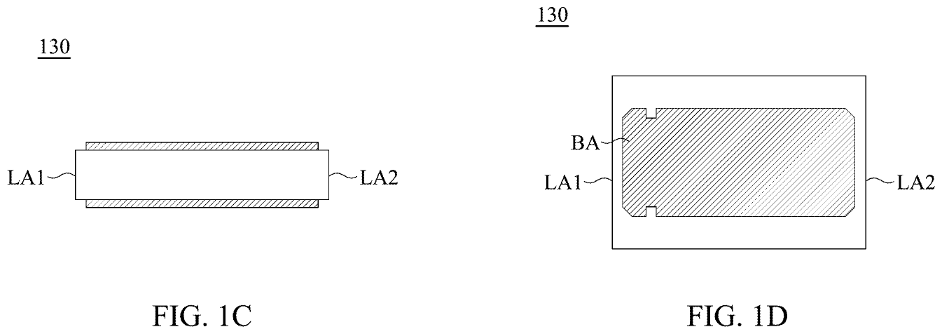

References are made to FIG. 1A and FIG. 1B. FIG. 1A is a schematic diagram of a light detection and ranging (LiDAR) system 100 according to some embodiments of the present disclosure. As illustrated in FIG. 1A and FIG. 1B, the LiDAR system 100 includes a driver 110, a detector 120A, a light emitting element 130, a collimating lens 140, a beam splitter 150, a detector 160, a reflecting element 170, a processor 180, and a lens 190. FIG. 1B is a top view diagram of the driver 110, the detector 120A, and the light emitting element 130 in FIG. 1A according to some embodiments of the present disclosure. The driver 110 can use driving signals to drive the light emitting element 130 to emit light. In some embodiments, the driver 110 may be implemented by an application specific integrated circuit (ASIC) or field-effect transistors made by GaN. The driver 110 needs to be able to endure a high instantaneous current. In general, it needs tens of amperes of current to drive the light emitting element 130 normally. Therefore, a distance between the driver 110 and the light emitting element 130 is usually in the millimeter level. For example, the distance between the driver 110 and the light emitting element 130 may be less than 10 millimeters. The detector 120A is disposed between the driver 110 and the light emitting element 130. In some embodiments, the light emitting element 130 is a laser diode (LD), but the present disclosure is not limited thereto. In some embodiments, the reflecting element 170 is a reflector.

References are made to FIG. 1C and FIG. 1D. FIG. 1C is a side view diagram of the light emitting element 130 according to some embodiments of the present disclosure. FIG. 1D is a top view diagram of the light emitting element 130 in FIG. 1C according to some embodiments of the present disclosure. As illustrated in FIG. 1C and FIG. 1D, the light emitting element 130 includes a light emitting surface LA1 and a light emitting surface LA2. In some embodiments, a routing area BA is arranged in the center of the light emitting element 130. Other traces may be disposed in the routing are BA.

As described above, the detector 120A is disposed between the driver 110 and the light emitting element 130. As illustrated in FIG. 1B, the driver 110 and the detector 120A are disposed at a side (for example, the left side on the figure) of the light emitting surface LA1, and the light emitting surface LA1 faces a light sensing surface LB of the detector 120A. The light emitting element 130 includes an axle AL. A center of the driver 110 and a center of the detector 120A form a connection line P1, and the connection line P1 is aligned with the axle AL.

As illustrated in FIG. 1A, the light emitting surface LA1 faces the detector 120A and emits light L1 towards the detector 120A. The light emitting surface LA2 faces the collimating lens 140 and emits light L2 towards the collimating lens 140. In some embodiments of the present disclosure, the light intensity of the light L1 emitted from the light emitting surface LA1 is less than the light intensity of the light L2 emitted from the light emitting surface LA2.

The detector 120A is configured to detect power of the light L1 emitted from the light emitting surface LA1, to measure the power of the light emitting element 130 in real time. The processor 180 is coupled to the detector 120A. In some embodiments, the processor 180 compares the detected power detected by the detector 120A with a threshold value, to determine whether the LiDAR system 100 is abnormal. For example, if the detected power detected by the detector 120A is less than the threshold value, the processor 180 determines that the LiDAR system 100 is abnormal and provides an alarm signal.

The collimating lens 140 is configured to collimate the light L2 emitted from the light emitting surface LA2 to generate collimation light CL1. The beam splitter 150 is configured to penetrate the collimation light CL1 to generate penetrated light TL. The reflecting element 170 is configured to reflect the penetrated light TL to generate reflected light RL1. The reflected light RL1 shines upon an object-under-test OB to generate scattered light SL of the object-under-test OB. The lens 190 is configured to collimate the scattered light SL of the object-under-test OB to generate collimation light CL2. The lens 190 will also allow more light to be collected. The reflecting element 170 is configured to reflect the collimation light CL2 to generate reflected light RL2. The beam splitter 150 is configured to reflect the reflected light RL2 to generate reflected light RL3. The detector 160 is configured to detect the reflected light RL3. The processor 180 is coupled to the detector 160. The processor 180 is configured to perform a time of flight measurement (ToF) calculation process according to the reflected light RL3 detected by the detector 160 and the illumination time of the light emitting element 130. In some embodiments, the detector 160 is disposed in a focus point of the lens 190.

In some embodiments, the detector 120A is without an amplifying function, and the detector 160 is with an amplifying function. For example, the detector 120A may be a photodiode (PD), and the detector 160 may be an avalanched photodiode (APD).

As described above, in the present disclosure, the detector 120A can detect the power of the light L1 emitted from the light emitting surface LA1, to measure the power of the light emitting element 130 in real time. With this configuration, it is known whether the light emitting element 130 or the LiDAR system 100 is abnormal in real time, to increase the reliability of the LiDAR system 100.

In addition, disposing the detector 120A between the driver 110 and the light emitting element 130 can reduce space. This configuration can avoid increasing the volume of the LiDAR system 100 and having a complex light path.

Furthermore, in some embodiments, the detector 120A may be implemented by a cheaper light detector. Therefore, increase of excessive cost can be avoided.

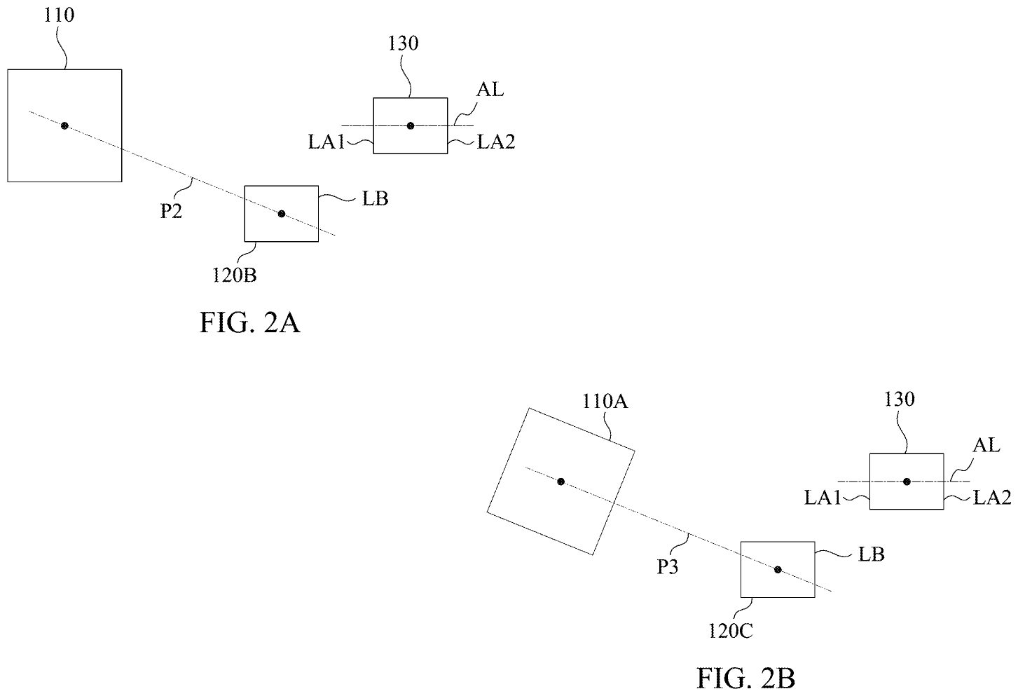

Refer to FIG. 2A. FIG. 2A is a top view diagram of the driver 110, a detector 120B, and the light emitting element 130 according to some other embodiments of the present disclosure. As illustrated in FIG. 2A, the driver 110 and the detector 120B are disposed at a side (for example, the left side on the figure) of the light emitting surface LA1, and a light sensing surface LB of the detector 120B faces another side (for example, the right side on the figure). The light emitting element 130 includes the axle AL. The center of the driver 110 and a center of the detector 120B form a connection line P2, and the connection line P2 is not aligned with the axle AL.

Reference is made to FIG. 2B. FIG. 2B is a top view diagram of the driver 110 A, a detector 120C, and the light emitting element 130 according to some other embodiments of the present disclosure. As illustrated in FIG. 2B, the driver 110A and the detector 120C are disposed at a side (for example, the left side on the figure) of the light emitting surface LA1, and a light sensing surface LB of the detector 120C faces another side (for example, the right side on the figure). The driver 110A is rotated by an angle with respect to the detector 120C. The light emitting element 130 includes the axle AL. A center of the driver 110A and a center of the detector 120C form a connection line P3, and the connection line P3 is not aligned with the axle AL.

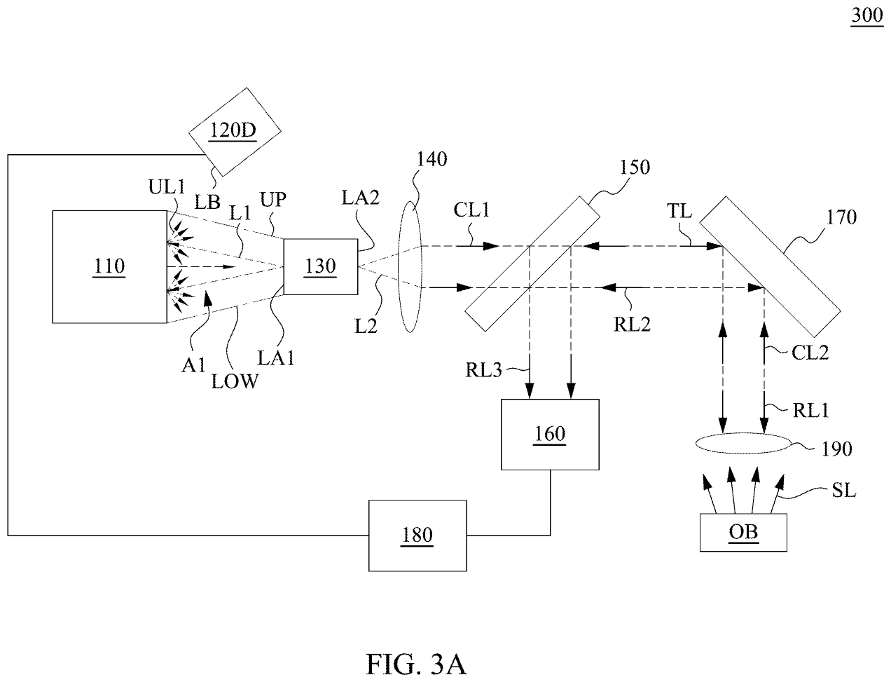

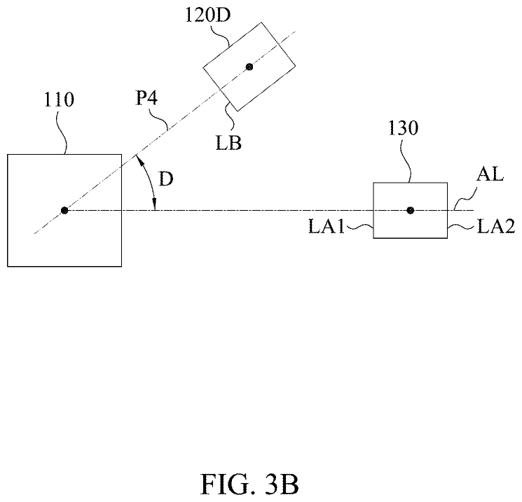

References are made to FIG. 3A and FIG. 3B. FIG. 3A is a schematic diagram of a LiDAR system 300 according to some embodiments of the present disclosure. FIG. 3B is a top view diagram of the driver 110, a detector 120D, and the light emitting element 130 in FIG. 3A according to some embodiments of the present disclosure. As illustrated in FIG. 3A, a region A1 is between the driver 110 and the light emitting element 130, and the range of the region A1 is a space surrounded by the right surface of the driver 110, the left surface of the light emitting element 130, a virtual upper surface UP, and a virtual lower surface LOW. The virtual upper surface UP is between the upper surface of the driver 110 and the upper surface of the light emitting element 130, and the virtual lower surface LOW is between the lower surface of the driver 110 and the lower surface of the light emitting element 130. The detector 120D is disposed outside the region A1. As illustrated in FIG. 3B, the driver 110 and the detector 120D are disposed at one side (for example, the left side on the figure) of the light emitting surface LA1, and a light sensing surface LB of the detector 120D faces the driver 110. The light emitting element 130 includes the axle AL. The center of the driver 110 and the center of the detector 120D form a connection line P4, and the connection line P4 is not aligned with the axle AL. For example, an acute angle D is formed between the connection line P4 and the axle AL.

Reference is made to FIG. 3A again. The driver 110 is configured to reflect the light L1 emitted from the light emitting surface LA1 of the light emitting element 130 to generate light-under-test UL1. The detector 120D is configured to receive and detect the light-under-test UL1 reflected by the driver 110, to measure the power of the light emitting element 130 in real time.

In the LiDAR system 300 in FIG. 3A, since the detector 120D is not disposed in region Al between the driver 110 and the light emitting element 130, a distance between the driver 110 and light emitting element 130 can be short to reduce space. For example, the distance between the driver 110 and light emitting element 130 may be less than 5 millimeters.

The collimating lens 140 is configured to collimate the light L2 emitted from the light emitting surface LA2 to generate the collimation light CL1. The beam splitter 150 is configured to penetrate the collimation light CL1 to generate the penetrated light TL. The reflecting element 170 is configured to reflect the penetrated light TL to generate the reflected light RL1. The reflected light RL1 shines upon the object-under-test OB to generate the scattered light SL of the object-under-test OB. The lens 190 is configured to collimate the scattered light SL of the object-under-test OB to generate the collimation light CL2. The reflecting element 170 is configured to reflect the collimation light CL2 to generate the reflected light RL2. The beam splitter 150 is configured to reflect the reflected light RL2 to generate the reflected light RL3. The detector 160 is configured to detect the reflected light RL3. The processor 180 is coupled to the detector 160. The processor 180 is configured to perform a ToF calculation process according to the reflected light RL3 detected by the detector 160 and illumination time of the light emitting element 130.

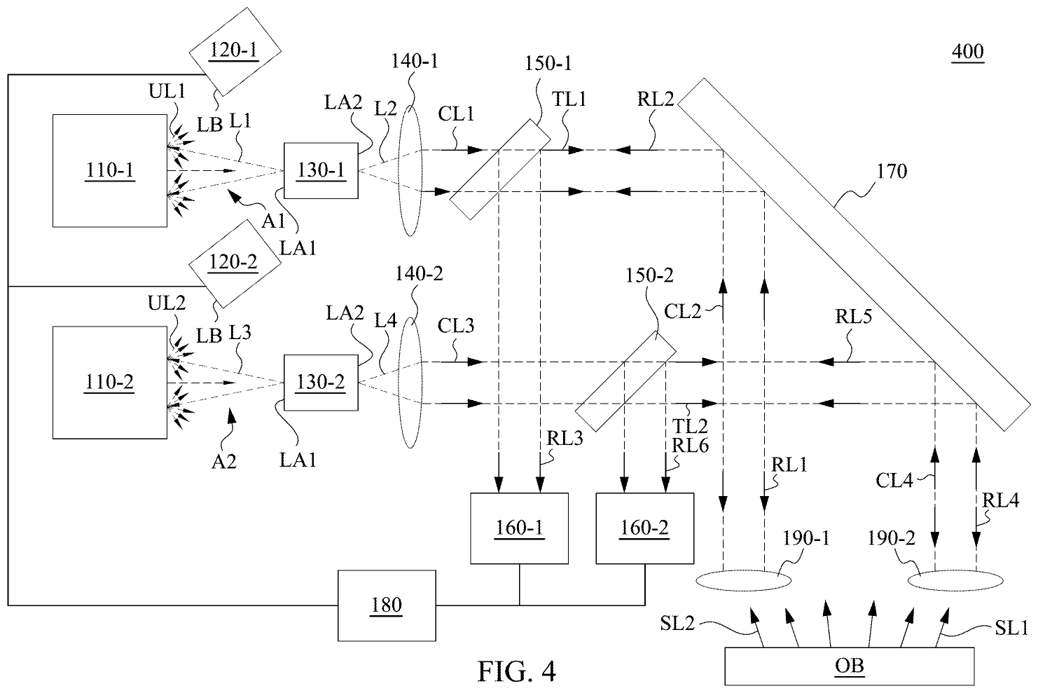

Reference is made to FIG. 4. FIG. 4 is a schematic diagram of a LiDAR system 400 according to some embodiments of the present disclosure. As illustrated in FIG. 4, the LiDAR system 400 includes drivers 110-1 and 110-2, detectors 120-1 and 120-2, light emitting elements 130-1 and 130-2, collimating lenses 140-1 and 140-2, beam splitters 150-1 and 150-2, detectors 160-1 and 160-2, a reflecting element 170, a processor 180, and lenses 190-1 and 190-2.

The configuration of the driver 110-1, the detector 120-1, the light emitting element 130-1, the collimating lens 140-1, the beam splitter 150-1, the reflecting element 170, and the lens 190-1 is similar to the LiDAR system 300 in FIG. 3A and forms a first light signal channel. The configuration of the driver 110-2, the detector 120-2, the light emitting element 130-2, the collimating lens 140-2, the beam splitter 150-2, the reflecting element 170, and the lens 190-2 is also similar to the LiDAR system 300 in FIG. 3A and forms a second light signal channel. In other words, the LiDAR system 400 in FIG. 4 is a multi-channel system and includes two light signal channels. In some other embodiments, the LiDAR system 400 may include more than two light signal channels.

In FIG. 4, the configuration of the driver 110-1(110-2), the detector 120-1(120-2), and the light emitting element 130-1(130-2) may be the same to the configuration of the driver 110, the detector 120D, and the light emitting element 130 in FIG. 3B. As illustrated in FIG. 4, the region A1 is formed between the driver 110-1 and the light emitting element 130-1. The detector 120-1 is disposed outside the region A1. To be more specific, the driver 110-1 and the detector 120-1 are disposed at a side (for example, the left side on the figure) of the light emitting surface LA1 of the light emitting element 130-1, and a light sense surface LB of the detector 120-1 faces the driver 110-1. The light emitting element 130-1 includes an axle (for example, the axle AL in FIG. 3B). A center of the driver 110-1 and a center of the detector 120-1 form a connection line (for example, the connection line P4 in FIG. 3B), and the connection line is not aligned with the axle of the light emitting element 130-1. For example, an acute angle (for example, the acute angle D in FIG. 3B) is formed between this connection line (for example, the connection line P4 in FIG. 3B) and the axle (for example, the axle in FIG. 3B) of the light emitting element 130-1. Similarly, a region A2 is formed between the driver 110-2 and the light emitting element 130-2. The detector 120-2 is disposed outside the region A2. To be more specific, the driver 110-2 and the detector 120-2 are disposed at a side (for example, the left side on the figure) of the light emitting surface LA1 of the light emitting element 130-2, and a light sense surface LB of the detector 120-2 faces the driver 110-2. The light emitting element 130-2 includes an axle (for example, the axle AL in FIG. 3B). A center of the driver 110-2 and a center of the detector 120-2 form a connection line (for example, the connection line P4 in FIG. 3B), and the connection line is not aligned with the axle of the light emitting element 130-2. For example, an acute angle (for example, the acute angle D in FIG. 3B) is formed between this connection line (for example, the connection line P4 in FIG. 3B) and the axle (for example, the axle in FIG. 3B) of the light emitting element 130-2.

The light emitting element 130-1 or 130-2 has the light emitting surface LA1 and the light emitting surface LA2 with different light intensities respectively. The light emitting surface LA1 and the light emitting surface LA2 of the light emitting element 130-1 are configured to emit the light L1 and the light L2 with different light intensities respectively. The driver 110-1 is configured to reflect the light L1 to generate the light-under-test UL1. The detector 120-1 is configured to detect the light-under-test UL1, to measure power of the light emitting element 130-1 in real time. The collimating lens 140-1 is configured to collimate the light L2 to generate the collimation light CL1. The beam splitter 150-1 is configured to penetrate the collimation light CL1 to generate the penetrated light TL1. The reflecting element 170 is configured to reflect the penetrated light TL1 to generate the reflected light RL1. The reflected light RL1 shines upon the object-under-test OB to generate scattered light SL1 of the object-under-test OB. The lens 190-1 is configured to collimate the scattered light SL1 of the object-under-test OB to generate the collimation light CL2. The reflecting element 170 is configured to reflect the collimation light CL2 to generate the reflected light RL2. The beam splitter 150-1 is configured to reflect the reflected light RL2 to generate the reflected light RL3. The detector 160-1 is configured to detect the reflected light RL3, such that the processor 180 performs the ToF calculation process. Similarly, the light emitting surface LA1 and the light emitting surface LA2 of the light emitting element 130-2 are configured to emit light L3 and light L4 with different light intensities respectively. The driver 110-2 is configured to reflect the light L3 to generate light-under-test UL2. The detector 120-2 is configured to detect the light-under-test UL2, to measure power of the light emitting element 130-2 in real time. The collimating lens 140-2 is configured to collimate the light L4 to generate collimation light CL3. The beam splitter 150-2 is configured to be penetrated by collimation light CL3 to generate penetrated light TL2. The reflecting element 170 is configured to reflect the penetrated light TL2 to generate reflected light RL4. The reflected light RL4 shines upon the object-under-test OB to generate scattered light SL2 of the object-under-test OB. The lens 190-2 is configured to collimate the scattered light SL2 of the object-under-test OB to generate collimation light CL4. The reflecting element 170 is configured to reflect the collimation light CL4 to generate reflected light RL5. The beam splitter 150-2 is configured to reflect the reflected light RL5 to generate reflected light RL6. The detector 160-2 is configured to detect the reflected light RL6, such that the processor 180 performs the ToF calculation process.

As illustrated in FIG. 4, since the detector 120-2 is disposed between the region A1 and the region A2 (on the light path of the light-under-test UL1 and on the light path of the light-under-test UL2), the detector 120-2 not only can block the light-under-test UL1 to prevent the light-under-test UL1 from interfering the second light communication channel, but also can block the light-under-test UL2 to prevent the light-under-test UL2 from interfering the first light communication channel. In other words, the Lidar system 400 in FIG. 4 can reduce crosstalk between different light communication channels.

As described above, the Lidar system of the present disclosure can measure the power of the light emitting element in real time, to increase the reliability of the Lidar system. In addition, in some embodiments, the detector is disposed between the driver and the light emitting element to reduce space, so as to avoid increasing the volume of the LiDAR system and complex light path. Furthermore, the Lidar system of the present disclosure is easy to manufacture, and has low cost.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A light detection and ranging (LiDAR) system, comprising:
a first driver;
a first light emitting element, wherein the first driver is configured to drive the first light emitting element to emit light; and
a first detector configured to detect power of the light.

2. The LiDAR system of claim 1, wherein the light comprises first light and second light, and the first light emitting element comprises a first light emitting surface emitting the first light, and a second light emitting surface emitting the second light.

3. The LiDAR system of claim 2, wherein the first detector is disposed between the first driver and the first light emitting element, and the first detector is configured to detect the power of the first light from the first light emitting surface.

4. The LiDAR system of claim 2, further comprising:
a first collimating lens configured to collimate the second light to generate first collimation light;
a first beam splitter configured to make the first collimation light penetrate through the beam splitter to generate penetrated light;
a reflecting element configured to reflect the penetrated light to generate first reflected light, and let the first reflected light shine upon an object-under-test to generate scattered light;
a first lens configured to collimate the scattered light of the object-under-test to generate second collimation light, wherein the reflecting element is further configured to reflect the second collimation light to generate second reflected light, and the beam splitter is further configured to reflect the second reflected light to generate third reflected light; and
a second detector configured to detect the third reflected light.

5. The LiDAR system of claim 2, wherein the first light emitting element comprises an axle, the first driver and the first detector are disposed at a side of the first light emitting surface, and a connection line of a center of the first driver and a center of the first detector is aligned with the axle.

6. The LiDAR system of claim 2, wherein the first light emitting element comprises an axle, the first driver and the first detector are disposed at a side of the first light emitting surface, and a connection line of a center of the first driver and a center of the first detector is not aligned with the axle.

7. The LiDAR system of claim 2, further comprising:
a processor configured to determine whether the LiDAR system is abnormal according to the detected power of the first light and a threshold value.

8. The LiDAR system of claim 2, wherein a first region is between the first driver and the first light emitting element, wherein the first light is emitted to the first driver, such that the first driver reflects the first light to generate first light-under-test,
wherein the first detector is disposed outside the first region and configured to detect power of the first light-under-test.

9. The LiDAR system of claim 8, further comprising:
a first collimating lens configured to collimate the second light to generate first collimation light;
a first beam splitter configured to make the first collimation light penetrate through the first beam splitter to generate first penetrated light;
a reflecting element configured to reflect the first penetrated light to generate first reflected light, and let the first reflected light shine upon an object-under-test to generate first scattered light; and
a first lens configured to collimate the first scattered light of the object-under-test to generate second collimation light, wherein the reflecting element is further configured to reflect the second collimation light to generate second reflected light, and the first beam splitter is further configured to reflect the second reflected light to generate third reflected light; and
a second detector configured to detect the third reflected light.

10. The LiDAR system of claim 9, wherein a distance between the first driver and the first light emitting element is less than 5 millimeters.

11. The LiDAR system of claim 9, wherein the first light emitting element comprises an axle, the first driver and the first detector are disposed at a side of the first light emitting surface, and a connection line of a center of the first driver and a center of the first detector is not aligned with the axle.

12. The LiDAR system of claim 9, further comprising:
a second driver,
a second light emitting element configured to emit third light and fourth light, wherein a second region is between the second driver and the second light emitting element, wherein the third light is emitted to the second driver, such that the second driver reflects the third light to generate second light-under-test;
a third detector disposed outside the second region and configured to detect power of the second light-under-test;
a second collimating lens configured to collimate the fourth light to generate third collimation light; and
a fourth detector configured to detect light associated with the third collimation light for the ToF calculation process.

13. The LiDAR system of claim 12, further comprising:
a second beam splitter configured to make the third collimation light penetrate through the second beam splitter to generate second penetrated light, wherein the reflecting element is further configured to reflect the second penetrated light to generate fourth reflected light, and let the fourth reflected light shine upon the object-under-test to generate second scattered light; and
a second lens configured to collimate the second scattered light of the object-under-test to generate fourth collimation light, wherein the reflecting element is further configured to reflect the fourth collimation light to generate fifth reflected light, and the second beam splitter is further configured to reflect the fifth reflected light to generate sixth reflected light, wherein the sixth reflected light is the light detected by the fourth detector.

14. The LiDAR system of claim 13, wherein the second light emitting element comprises a third light emitting surface and a fourth light emitting, wherein the third light emitting surface and the fourth light emitting surface are configured to emit the third light and the fourth light respectively.

15. The LiDAR system of claim 14, wherein the second light emitting element comprises an axle, the second driver and the third detector are disposed at a side of the third light emitting surface, and a connection line of a center of the second driver and a center of the third detector is not aligned with the axle.

16. The LiDAR system of claim 13, wherein the third detector is disposed between the first region and the second region.
